(19) United States
(12) Patent Application Publication
(10) Pub. No.: US 2009/0157814 A1
(43) Pub. Date: Jun. 18, 2009

(54) Method and apparatus for providing social networking service based on peer-to-peer network

(75) Inventors: Il Woo Lee, Daejeon (KR); Moonok Choi, Daejeon (KR); Ho Jin Park, Daejeon (KR); Kwang Roh Park, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/155,550

(22) Filed: Jun. 5, 2008

(30) Foreign Application Priority Data
Dec. 18, 2007 (KR) 10-2007-0133676

(51) Int. Cl. G06F 15/16

(52) U.S. Cl. 709/204

(57) ABSTRACT

A Peer-to-Peer (P2P) based social networking service method for providing a social networking service, includes transmitting a request to a peer group and performing a group-based social networking service; transmitting news or a question to peers in the peer group, and then receiving a response to the question; and storing the received information in a storage medium, and uploading specific information among the stored to a rendezvous peer. The method further includes delivering the uploaded specific information to another rendezvous peer in a network. A P2P based social networking service system includes a P2P middleware unit for providing services of communicating between and grouping the peers; a P2P service application program interface layer for providing a network element function; and a P2P application service layer for calling the network element function, if required, to thereby provide a user with a P2P based network service.

### CROSS-REFERENCE(S) TO RELATED APPLICATIONS

The present invention claims priority of Korean Patent Application No. 10-2007-0133676, filed on Dec. 18, 2007, which is incorporated herein by reference.

### FIELD OF THE INVENTION

The present invention relates to a peer-to-peer (P2P) based networking service; and, more particularly, to a P2P based social networking service method and apparatus capable of appropriately providing a social networking service under P2P environments.

### BACKGROUND OF THE INVENTION

An Internet-based application needs a variety of requirements, for example, extensibility, security and reliability, flexibility associated with new services, and a Quality of Service (QoS). In order to satisfy the above-mentioned requirements in a basic client/server scheme, complexity and high cost are encountered. But, a Peer-to-Peer (P2P) communication scheme to which all kinds of distributed resources can access provides a much easier solution.

Generally, the P2P communication technology provides a service for sharing resources of users on a variety of wired or wireless networks using terminals of the users under a ubiquitous environment. In other words, as the communication environment and a personal terminal's performance are improved, demands of content sharing and service interworking between different devices, anytime and anywhere, are increasing. The P2P communication technology implements a virtual space for providing a seamless connection between the personal terminals, so that services and contents are searched and shared between P2P based devices.

From the viewpoint of the service, in future, it is expected that the Internet activities (e.g., E-mail or Internet-banking) will be mainly conducted through a mobile phone, the mobile phone will substitute for a current server portal, and a location information service using a user's location information will be developed. Further, many problems caused by the client-server environment appears, and the reliability of large amounts of information circulated on the Internet is very low. In other words, it needs to be noted that all information circulated on the Internet is not true. Therefore, users must devise how to acquire reliable and meaningful information from among excessive amount of Internet information.

For example, there are a variety of social networking services in the conventional service, for example, a BrainN (http://brainn.co.kr/news.jsp) and Facebook (http://www.facebook.com/). User's evaluation is reflected in the news importance and reliability. And, an exchange between users, a finding-person service, and a profile-searching service are being provided to users. However, the method providing the above-mentioned services has a Single Point of Failure (SPOF) problem that all services may be interrupted by a faulty operation of only one component.

The above-mentioned SPOF problem is considered to be a serious problem likely to be generated in the current client-server environment. In order to solve the SPOF problem, a clustering method may be adapted to implement high availability such as multiplexing of a system server, however, resulting in not an ultimate solution but an increased cost of production.

As stated above, using the conventional P2P service, a user cannot receive a desired service unless the user has accessed a server, and there are needed large amounts of costs due to a server duplexing and a clustering, in order to increase the server's-availability.

Therefore, at present, required is to provide a user with a way or a service for acquiring more important, reliable, and valuable information.

### SUMMARY OF THE INVENTION

It is, therefore, a primary object of the present invention to provide a method for easily providing a social networking service, which will be used as a principal service on the basis of a universal P2P platform irrelevant to application characteristics.

It is another object of the present invention to provide a universal P2P platform which can easily construct a community for a social: networking service by using a peer group management function.

In accordance with one aspect of the present invention, there is provided a Peer-to-Peer (P2P) based social networking service method for providing a service user, who owns a peer terminal equipped with a P2P service platform, with a social networking service, including:

transmitting a join request to a peer group which the service user wants to communicate with and performing a group-based social networking service; transmitting news or a question to peers in the peer group, and then receiving a response to the question; storing the received information in a corresponding storage medium, and uploading specific information among the stored information to a rendezvous peer; and delivering the uploaded specific information to another rendezvous peer in a network.

The P2P based social networking service method may further include performing peer initialization for initiating a peer's service, and then determining whether or not the service is a group-based service; if the group-based service is not determined, searching for information of an edge peer on the network, and then registering the searched peer as an interest-peer list in a storage medium contained in a local peer; performing a P2P-based service; if the group-based service is determined, depending on whether or not a new peer group is generated, searching for information of either the new peer group or a existing peer group; and registering the searched peer group information in the storage medium contained in the local peer.

Preferably, the transmitting of the news or the question to the peers in the peer group includes transmitting information for evaluating reliability based on an additionally-defined news manufacturing format; and generating and transmitting a question message to an activated peer in the group.

Further, preferably, the uploading of the specific information to the rendezvous peer is determined by a number of recommendations or selecting weight.

The uploading of the specific information to the rendezvous peer may include an evaluation method based on an information priority policy.

The peer initialization for initiating the peer's service may include detecting a corresponding rendezvous peer on the basis of construction information of the edge peer; and transmitting a message having news information and reliability evaluation information, which are written by the pre-defined format, to the corresponding rendezvous peer.

In accordance with another aspect of the invention, there is provided a Peer-to-Peer (P2P) based social networking service system including a P2P middleware unit for providing services of communicating between peers and grouping the peers on the basis of an operating system, a matching layer, and a transport layer; a P2P service application program interface layer for providing a network element function as a library format when a P2P application service between the peers is generated; and a P2P application service layer for calling the network element function of the P2P service application program interface layer if required to thereby provide a user with a P2P based network service.

The network element function may include at least one of a file transfer function, a message transfer function, and a message/file management function.

Further, the P2P based network service may includes at least one of a file transfer service, a messenger service, a location information service, and a social networking service.

Moreover, the P2P middleware unit may include a Peer Discovery Protocol (PDP) block for providing a protocol for advertising resources and existences of each of the peers to other peers; a Peer Resolver Protocol (PRP) block for providing a service of responding to a query that each of the peers transmits to said other peers; a Peer Information Protocol (PIP) block for providing a service of allowing said each of the peers to acquire status information of said other peers; a Peer membership Protocol (PMP) block for providing a service of allowing said each of the peers to organize it self and of grouping a peer group; a Pipe Binding Protocol (PBP) block for forming a virtual pipe or a communication channel between individual peers; and a Peer Endpoint protocol (PEP) block for providing route information in order to transmit a message from a first peer to a second peer.

Preferably, the P2P service application program interface layer includes a peer management block for managing peer information and providing a function of communicating with other peers; a peer group management block for generating a group list when a peer group is detected; and a peer and group information database for storing interest peer information registered by the user and the group list generated by the peer group management block.

With the present invention, the social networking service which is widely used recently can be provided through the P2P network. Such a method can solve the SPOF problem generated on the client-server environment providing the conventional social networking service and problems generated on the centralized server system used conventionally, so as to provide more sustainable and efficient services. Further, reliable information from a group consisting of members favorable to the user can be acquired and highly reliable and real-time social networking service can be provided.

### BRIEF DESCRIPTION OF THE DRAWINGS

The above and other objects and features of the present invention will become apparent from the following description of embodiments, given in conjunction with the accompanying drawings, in which:

FIG. 1 is a block diagram illustrating a service platform mounted in a terminal to provide a P2P based social networking service in accordance with the present invention;

FIGS. 2A and 2B describes a flow chart illustrating a service providing process for an edge terminal to be provided with a P2P based social networking service in accordance with the present invention; and

FIG. 3 is a service conceptual diagram illustrating a P2P virtual network and groups to provide a P2P based social networking service in accordance with the present invention.

### DETAILED DESCRIPTION OF THE EMBODIMENTS

Now, embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

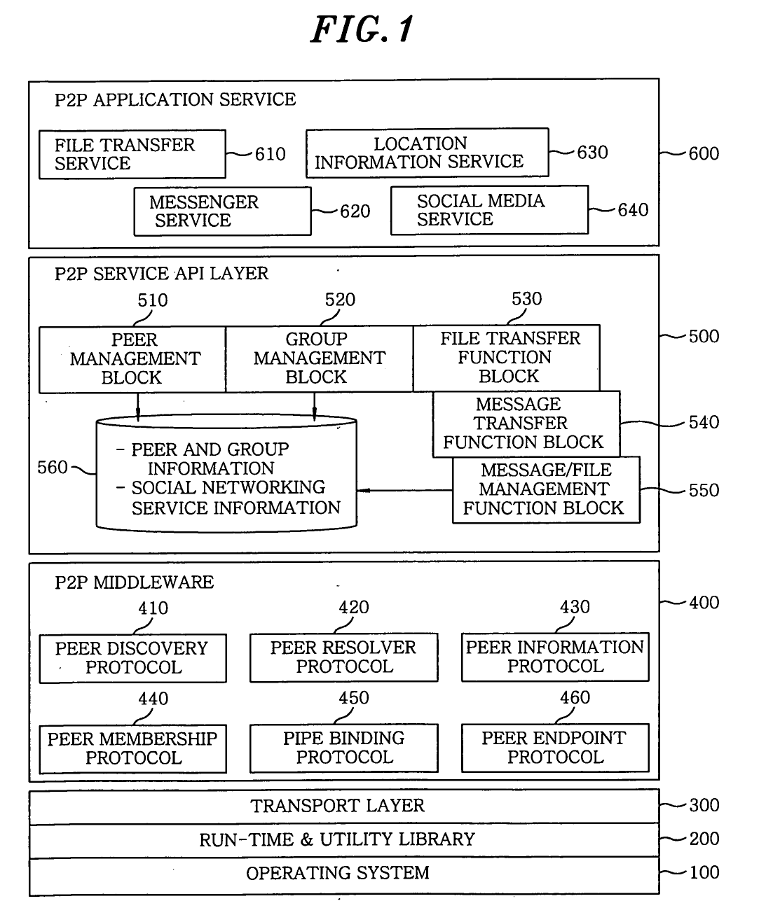

FIG. 1 is a block diagram illustrating a service platform mounted to a terminal to provide a P2P based social networking service in accordance with the present invention.

Referring to FIG. 1, a lower part of the social networking service system sequentially includes an operating system 100 and a run-time & utility-library part 200, such as a parser or database management system (DBMS) required for operating the application.

A transport layer 300 such as TCP/IP is located on the run-time & utility-library part 200 of the social networking service system, and a P2P middleware 400 is located on the transport layer 300.

The P2P middleware 400 for providing a service includes a plurality of protocols.

Firstly, a Peer Discovery Protocol (PDP) 410 provides a protocol required for advertising resources and existences of individual peers to other peers. The resources of all peers are described and published by the advertisement. The advertisement is configured in the form of metadata describing network resources. Generally, the advertisement is written in extensible Markup Language (XML).

A Peer Resolver Protocol (PRP) 420 is used when peers transmit queries to at least one target peer so that the target peer answers the query. The PRP 420 is a query/response protocol. A response message is matched with the query by a unique identifier contained in a main part of a message. If the peers are found by the PDP 410, the query can be transmitted to other peers.

A Peer Information Protocol (PIP) 430 is a protocol used when a peer acquire status information of other peers. The status information includes a current status of a peer, a peer activation time, or a traffic load.

A Peer Membership Protocol (PMP) 440 is a protocol, which enables peers to organize themselves and perform grouping of peer groups. The peer groups are formed by a logical boundary which the peers are interested in. The PMP 440 is used when the peers enter the peer group found by the PDP 410 or leave the peer group.

A Pipe Binding Protocol (PBP) 450 is a protocol, which forms a virtual pipe or communication channel between one or more peers. The PBP 450 is used by peers connected to at least two connection end points. The pipe provides a communication mechanism between peers.

A Peer Endpoint protocol (PEP) 460 is a protocol which can find a route so that one peer can transmit a message to another peer. Provided that a first peer A transmits a message to a second peer C and there is no direct connection between the first peer A and the second peer C, the first peer A may find a path for delivering a message to the second peer C. The PEP 460 is used to determine route information. If the link on the network toward the second peer C becomes unavailable any more, a new path toward the second peer C via other peers may be generated by the PEP 460.

The above-mentioned middleware core protocol is operated based on the operating system 100, the run-time & utility-library (matching layer) 200, and the transport layer 300.

In the meantime, a service developer can develop a service function in a manner that the application calls directly a middleware, however, in this case, the developer must fully understand internal protocols and source codes. Therefore, there is needed a service Application Program Interface (API) layer 500 capable of being easily used in the application.

The API layer 500 includes a peer management block 510. The peer management block 510 manages peer information, and provides a function for communicating with other peers. If the peers are detected in a current P2P network, the detected peers are stored in a peer list. And, if a user registers a peer in the peer list as an interest peer, it is stored in a local disc or a storage medium 560.

If a desired group is detected, a peer group management block 520 stores the detected group in a group list. If the user registers a specific peer group among the group list as an interest peer group, it is permanently stored in a local disc or storage medium. In this case, if the group type is such a peer group that requires security information, peer group advertisement information and a group access key (password) issued by the corresponding group are simultaneously stored.

The API layer 500 includes a basic service blocks such as blocks implementing, in a library-form, a function of a network element which is basically necessary for generating and providing a P2P application service, for example, a file transfer service block 530, a message transfer service block 540, and a message/file management function block 550. The file transfer service block 530, the message transfer service block 540, and the message/file management function block 550. Such element service blocks 530, 540 and 550 are called by the upper application service module, depending on necessary function, to thereby be used.

The P2P application service layer 600 performs an application service of a service execution file level which is substantially provided to a user. The P2P application service layer 600 includes a file transfer service 610, a messenger server 620, a location information service 630, and a social networking service 640. Besides the above, the present invention may provide a variety of P2P based services.

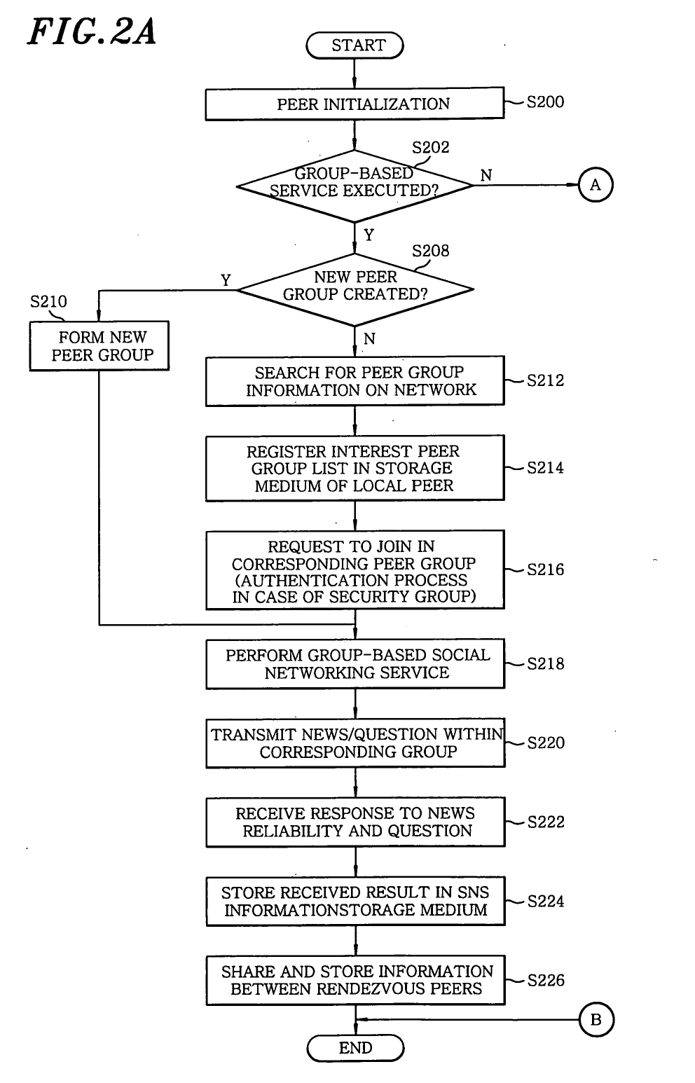

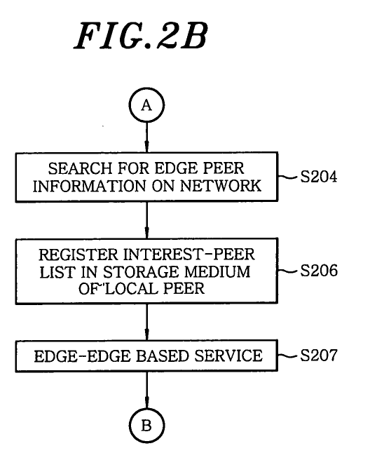

FIGS. 2A and 2B describe a flow chart illustrating a P2P based social networking service method in accordance with the present invention.

Referring to FIGS. 2A and 2B, the present invention discloses a method for allowing a service user, who owns a peer terminal equipped with the P2P service platform of FIG. 1, to be provided with a social networking service.

As shown in FIGS. 2A and 2B, peer initialization is performed at step S200.

The peer initialization is as follows. A service user, who desires to receive the P2P based social networking service, has a peer terminal equipped with the P2P service platform in accordance with the present invention; gains access to an edge peer to use a desired service; logs in with his or her own peer terminal; and sets a peer environmental information such as a peer name of the peer terminal and a rendezvous and a relay peer information.

The above-mentioned process for establishing the peer environmental information includes detecting a corresponding rendezvous peer by an edge peer based on construction information of the edge peer; and transmitting a message including both news information and reliability evaluation information to the corresponding rendezvous peer in a pre-defined format.

Meanwhile, at step S202, it is determined whether a group-based service is performed on the basis of the initial setting information of the above step S200.

If the group-based service is determined not to be performed at step S202, information of a counterpart peer on the network is searched at step S204.

Among the searched counterpart peers, the user registers interest peers, which the user wants to communicate with, in an interest peer list of a local peer at step S206.

Among the registered interest peers, the user selects a peer which will be actually communicated with and communicates with the selected peer to thereby perform a service at step S207.

On the other hand, when the group-based service is determined to be performed at step S202, the user determines whether to generate a new peer group or to join in an old peer group at step S208.

If the user decides to generate the new peer group at step S208, a new group is generated on the basis of a group name, a security policy, and a group password at step S210.

If the user decides to join in the old group and to be provided with a service at step S208, a peer group formed on the network is searched at step S212.

Based on information about the peer group searched at the above step 212, a peer group, which the user wants to join in, is registered in an interest peer group list of the local peer at step S214.

The user transmits a join request so as to join in a specific peer group among the interest peer groups, registered at the above step S214, at step S216.

At step S218, the group-based social networking service is activated to thereby perform the service after the user has joined in the group selected at the above step s216.

After the service has been activated at the above step S218, the user transmits written news or a question about desired information to peers within a corresponding group at step S220. In this case, the transmitting the news or question to the peers within the group at step S220 includes information whose reliability can be evaluated based on an additionally defined news manufacturing format. The transmitting is characterized in that generated and transmitted to an activated peer (i.e., ON-status peers) within the above group is a question message such as information about a restaurant adjacent to the peers within the group or a question about now-showing movie.

At step S222, received is a response to the above-mentioned question message of the above step S220.

At step S224, the information received from one or more peers and obtained at step S222 is stored in an information storage medium associated with the social networking service (SNS).

Among the information stored at step S224, principal information (specific information) is determined in accordance with an evaluation reference, and is uploaded to a neighboring rendezvous peer at step S226. In this case, a social networking service characteristic makes a media user determine the principal information of above step S226. The determining includes a manner determined by the number of recommendations or selecting weight, and another manner of evaluating based on other information priority policy. At the above step 226, limitations on resources of the edge peers defies to store lots of information, so, the information may be uploaded to the rendezvous peer acting as a super-peer having a relatively sufficient amount of resources.

Finally, the information uploaded between the rendezvous peers is shared and stored at step S228. In more detail, at step S228, the information is uploaded to the rendezvous peer, which is always in an active state, rather than the edge peer, which is not always in the active state, whereby an environment that the principal information within the group can be always accessed is established.

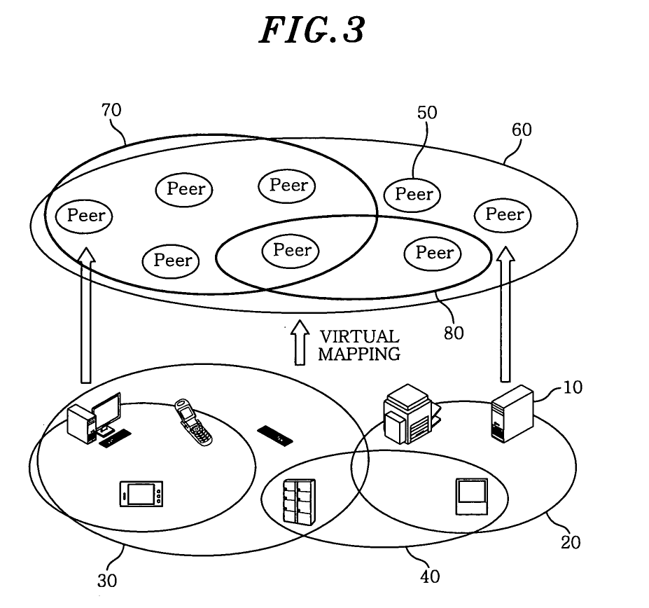

FIG. 3 is a service conceptual diagram in which a virtual network consists of a variety of terminals and groups are made in the virtual network.

From the viewpoint of a physical network, the various terminals 10 are implemented with a variety of peers 20, 30, and 40 in an office, home, or ad-hoc network. By virtual mapping, such terminals 10 construct a virtual network 60 on the P2P network.

Each of the terminals 10 in the P2P virtual network 60 transmits or receives a service as a peer 50. By grouping the peers in the P2P virtual network 60, security-peer groups 70 and 80 are formed. Through communication between the peers in the groups 70 and 80, the social networking service is used.

The above-mentioned method in accordance with the present invention can be implemented with a program, so that it can be stored in a computer-readable recording medium (e.g., CD-ROM, RAM, ROM, floppy disc, HDD, optical disc).

While the invention has been shown and described with respect to the embodiments, it will be understood by those skilled in the art that various changes and modifications may be made without departing from the scope of the invention as defined in the following claims.

What is claimed is:

1. A Peer-to-Peer (P2P) based social networking service method for providing a service user, who owns a peer terminal equipped with a P2P service platform, with a social networking service, comprising:
transmitting a join request to a peer group which the service user wants to communicate with and performing a group-based social networking service;
transmitting news or a question to peers in the peer group, and then receiving a response to the question;
storing the received information in a corresponding storage medium, and uploading specific information among the stored information to a rendezvous peer; and
delivering the uploaded specific information to another rendezvous peer in a network.

2. The P2P based social networking service method of claim 1, further comprising:
performing peer initialization for initiating a peer's service, and then determining whether or not the service is a group-based service;
if the group-based service is not determined, searching for information of an edge peer on the network, and then registering the searched peer as an interest-peer list in a storage medium contained in a local peer;
performing a P2P-based service;
if the group-based service is determined, depending on whether or not a new peer group is generated, searching for information of either the new peer group or a existing peer group; and
registering the searched peer group information in the storage medium contained in the local peer.

3. The P2P based social networking service method of claim 1, wherein the transmitting of the news or the question to the peers in the peer group includes:
transmitting information for evaluation reliability based on an additionally-defined news manufacturing format; and
generating and transmitting a question message to an activated peer in the group.

4. The P2P based social networking service method of claim 1, wherein the uploading of the specific information to the rendezvous peer is determined by a number of recommendations or selecting weight.

5. The P2P based social networking service method of claim 1, wherein the uploading of the specific information to the rendezvous peer includes an evaluation method based on an information priority policy.

6. The P2P based social networking service method of claim 2, wherein the peer initialization for initiating the peer's service includes:
detecting a corresponding rendezvous peer on the basis of construction information of the edge peer; and
transmitting a message having news information and reliability evaluating information, which are written by the pre-defined format, to the corresponding rendezvous peer.

7. A Peer-to-Peer (P2P) based social networking service system comprising:
a P2P middleware unit for providing services of communicating between peers and grouping the peers on the basis of an operating system, a matching layer, and a transport layer;
a P2P service application program interface layer for providing a network element function as a library format when a P2P application service between the peers is generated; and
a P2P application service layer for calling the network element function of the P2P service application program interface layer if required to thereby provide a user with a P2P based network service.

8. The P2P based social networking service system of claim 7, wherein:
the network element function includes at least one of a file transfer function, a message transfer function, and a message/file management function.

9. The P2P based social networking service system of claim 7, wherein:
the P2P based network service includes at least one of a file transfer service, a messenger service, a location information service, and a social networking service.

10. The P2P based social networking service system according to claim 7, wherein the P2P middleware unit includes:
a Peer Discovery Protocol (PDP) block for providing a protocol for advertising resources and existences of each of the peers to other peers;
a Peer Resolver Protocol (PRP) block for providing a service of responding to a query that each of the peers transmits to said other peers;
a Peer Information Protocol (PIP) block for providing a service of allowing said each of the peers to acquire status information of said other peers;
a Peer membership Protocol (PMP) block for providing a service of allowing said each of the peers to organize it self and of grouping a peer group;
a Pipe Binding Protocol (PBP) block for forming a virtual pipe or a communication channel between individual peers; and
a Peer Endpoint protocol (PEP) block for providing route information in order to transmit a message from a first peer to a second peer.

11. The P2P based social networking service system of claim 7, wherein the P2P service application program interface layer includes:
a peer management block for managing peer information and providing a function of communicating with other peers;
a peer group management block for generating a group list when a peer group is detected; and
a peer and group information database for storing interest peer information registered by the user and the group list generated by the peer group management block.
